(19) United States
(12) Patent Application Publication
(10) Pub. No.: US 2023/0266012 A1
(43) Pub. Date: Aug. 24, 2023

(54) MIXER ASSEMBLY WITH A CATALYTIC METAL COATING FOR A GAS TURBINE ENGINE

(71) Applicant: General Electric Company, Schenectady, NY (US)

(72) Inventors: Lawrence B. Kool, Clifton Park, NY (US); Bernard P. Bewlay, Niskayuna, NY (US); Byron A. Pritchard, Loveland, OH (US); Ramal Janith Samarasinghe, Schenectady, NY (US); Michael A. Benjamin, Cincinnati, OH (US); Lakshmi Krishnan, Clifton Park, NY (US); Hrishikesh Keshavan, Watervliet, NY (US)

(21) Appl. No.: 17/651,685

(22) Filed: Feb. 18, 2022

(51) Int. Cl. F23R 3/40; F23R 3/14; F23R 3/34; F23R 3/28

(52) U.S. Cl. CPC F23R 3/40; F23R 3/14; F23R 3/343; F23R 3/286

(57) ABSTRACT

A mixer assembly for a gas turbine engine. The mixer assembly includes a housing and a fuel injection port. The housing has a passage formed therein, and the housing includes a passage wall facing the passage. The fuel injection port is fluidly connected to a fuel source and is configured to inject a hydrocarbon fuel into the passage. At least a portion of the passage wall is a coated passage wall. The coated passage wall is (i) coated with a layer of a catalytic metal and (ii) located downstream of the fuel injection port.

### TECHNICAL FIELD

The present disclosure relates to mixer assemblies, particularly mixer assemblies used in gas turbine engines, and, more particularly, mixer assembles with a catalytic metal coating for gas engine turbines.

### BACKGROUND

Gas turbine engines include surfaces that contact hydrocarbon fluids, such as fuels and lubricating oils. Carbonaceous deposits (also known as coke) may form on these surfaces when exposed to the hydrocarbon fluids at elevated temperatures, resulting in carbon becoming attached to surfaces contacted by a fuel or oil and building up as deposits on those surfaces contacted by a fuel or oil.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic perspective view of an aircraft having a gas turbine engine according to an embodiment of the present disclosure.

FIG. 2 is a schematic, cross-sectional view, taken along line 2-2 in FIG. 1, of the gas turbine engine of the aircraft shown in FIG. 1.

FIG. 3 is a schematic, cross-sectional view of a combustor of the gas turbine engine shown in FIG. 2 according to an embodiment of the present disclosure. FIG. 3 is a detail view showing detail 3 in FIG. 2.

FIG. 4 is a schematic, cross-sectional view of a mixer assembly of the combustor in FIG. 3. FIG. 4 is a detail view showing detail 4 in FIG. 3.

FIG. 5 is a schematic, cross-sectional view of a combustor of the gas turbine engine shown in FIG. 2 according to another embodiment of the present disclosure. FIG. 5 is a detail view showing detail 3 in FIG. 2.

FIG. 6 is a schematic, cross-sectional view of a mixer assembly of the combustor in FIG. 5. FIG. 6 is a detail view showing detail 6 in FIG. 5.

### DETAILED DESCRIPTION

Features, advantages, and embodiments of the present disclosure are set forth or apparent from a consideration of the following detailed description, drawings, and claims. Moreover, it is to be understood that the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “directly upstream” or “directly downstream,” when used to describe the relative placement of components in a fluid pathway, refer to components that are placed next to each other in the fluid pathway without any intervening components between them other than an appropriate fluid coupling, such as a pipe, tube, valve, or the like, to fluidly couple the components. Such components may be spaced apart from each other with intervening components that are not in the fluid pathway.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” is not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values, and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As noted above, coke deposition may occur on surfaces of a gas turbine engine that are exposed to hydrocarbon fluids, such as fuels and lubricating oils, at elevated temperatures. The fuel nozzle and swirler (collectively, a mixer assembly) used in a combustor for a gas turbine engine includes such surfaces. The fuel nozzle aft heat shield (FN-AHS) protects the fuel nozzle from hot combustion gases during engine operation. Surfaces of the FN-AHS and other surfaces of the mixer assembly are exposed to hydrocarbon fluids, such as fuel, and operation of the gas turbine engine, particularly, continuous operation at cruise for aircraft gas turbine engines, can result in significant build-up of coke and/or partially burned fuel deposits on exposed surfaces of the FN-AHS and the mixer assembly. Coke can build up in considerable thickness, and large pieces of coke can shed off these surfaces, becoming internal domestic objects that can cause significant damage to components downstream of the fuel nozzle (hot gas path components). Some of these components have thermal barrier coatings (TBCs). The resulting internal domestic object impact damage (DoD) results in spallation of the thermal barrier coating and, therefore, reduces the durability of components such as combustors, nozzles, shrouds, and airfoils.

The embodiments discussed herein apply a coating of a catalytic metal to these surfaces of the mixer assembly and the fuel nozzle. Suitable catalytic metals include gold and the platinum group metals, such as, ruthenium, rhodium, palladium, osmium, iridium, and platinum. In some embodiments, palladium, platinum, and gold may be preferred catalytic metals. Without the catalytic metal coating, the coke bonds more strongly to the metallic components in the mixer assembly and the fuel nozzle, leading to the formation of larger coke particles that can shed or spall off during operation, as discussed above. As will be discussed further below, the catalytic metal prevents such build-up and spallation. Without intending to be bound to any theory, the catalytic metal coating promotes the formation of filamentary coke, rather than large granular coke. The filamentary coke does not bond to the catalytic metal surface of the mixer assembly and the fuel nozzle, and the filamentary coke can be easily removed during operation of the mixer assembly and the fuel nozzle in the combustor.

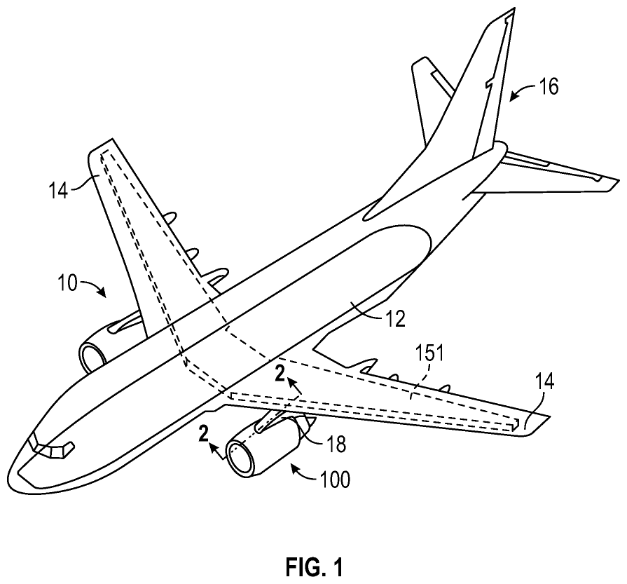

The mixer assembly discussed herein is particularly suitable for use in engines, such as a gas turbine engine used on an aircraft. FIG. 1 is a perspective view of an aircraft 10 that may implement various preferred embodiments. The aircraft 10 includes a fuselage 12, wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 1 includes a pair of engines 100. In this embodiment, each engine 100 is attached to one of the wings 14 by a pylon 18 in an under-wing configuration. Although the engines 100 are shown attached to the wing 14 in an under-wing configuration in FIG. 1, in other embodiments, the engine 100 may have alternative configurations and be coupled to other portions of the aircraft 10. For example, the engine 100 may additionally or alternatively include one or more aspects coupled to other parts of the aircraft 10, such as, for example, the empennage 16, and the fuselage 12.

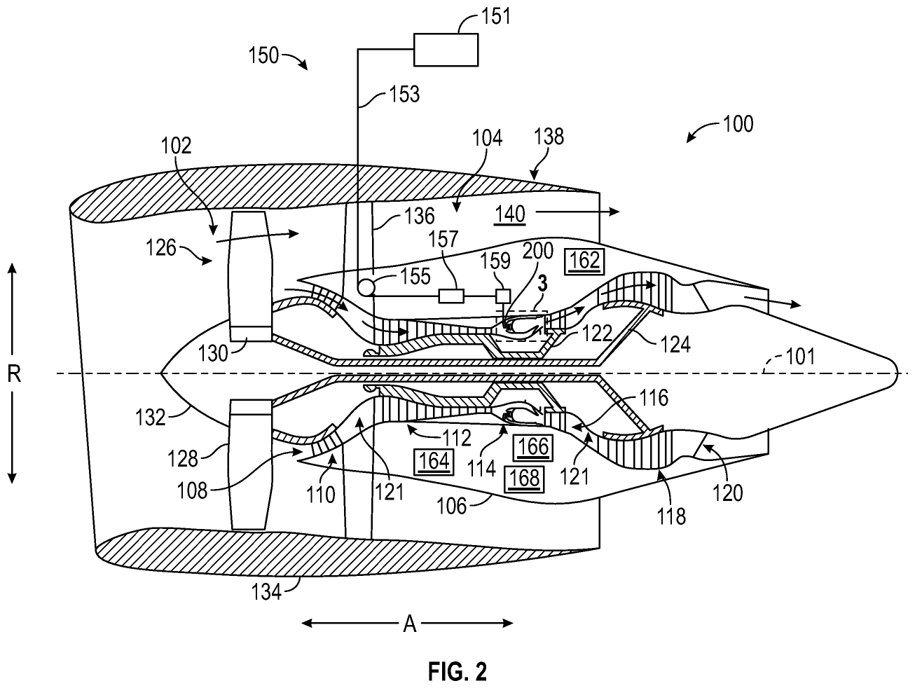

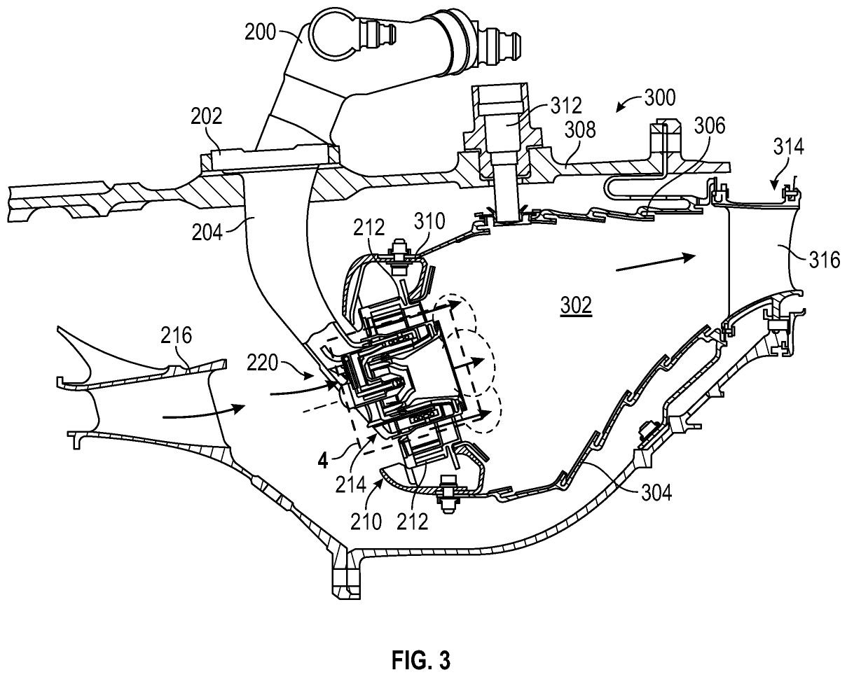

As will be described further below with reference to FIG. 2, the engines 100 shown in FIG. 1 are gas turbine engines that are each capable of selectively generating a propulsive thrust for the aircraft 10. The amount of propulsive thrust may be controlled at least in part based on a volume of fuel provided to the gas turbine engines 100 via a fuel system 150 (see FIG. 3). An aviation turbine fuel in the embodiments discussed herein is a combustible hydrocarbon liquid fuel, such as a kerosene-type fuel, having a desired carbon number. The fuel is stored in a fuel tank 151 of the fuel system 150. As shown in FIG. 1, at least a portion of the fuel tank 151 is located in each wing 14 and a portion of the fuel tank 151 is located in the fuselage 12 between the wings 14. The fuel tank 151, however, may be located at other suitable locations in the fuselage 12 or the wing 14. The fuel tank 151 may also be located entirely within the fuselage 12 or the wing 14. The fuel tank 151 may also be separate tanks instead of a single, unitary body, such as, for example, two tanks each located within a corresponding wing 14.

Although the aircraft 10 shown in FIG. 1 is an airplane, the embodiments described herein may also be applicable to other aircraft 10, including, for example, helicopters and unmanned aerial vehicles (UAV). Preferably, the aircraft discussed herein are fixed-wing aircraft or rotor aircraft that generate lift by aerodynamic forces acting on, for example, a fixed wing (e.g., wing 14) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the engines 100 used in the propulsion system for the aircraft 10 shown in FIG. 1. The cross-sectional view of FIG. 2 is taken along line 2-2 in FIG. 1. For the embodiment depicted in FIG. 2, the engine 100 is a high bypass turbofan engine. The engine 100 may also be referred to as a turbofan engine 100 herein. The turbofan engine 100 has an axial direction A (extending parallel to a longitudinal centerline 101, shown for reference in FIG. 2), a radial direction R, and a circumferential direction. The circumferential direction (not depicted in FIG. 2) extends in a direction rotating about the axial direction A. The turbofan engine 100 includes a fan section 102 and a turbomachine 104 disposed downstream from the fan section 102.

The turbomachine 104 depicted in FIG. 2 includes a tubular outer casing 106 (also referred to as a housing or nacelle) that defines an inlet 108. In this embodiment, the inlet 108 is annular. The outer casing 106 encases an engine core that includes, in a serial flow relationship, a compressor section including a booster or low-pressure (LP) compressor 110 and a high-pressure (HP) compressor 112, a combustion section 114, a turbine section including a high-pressure (HP) turbine 116 and a low-pressure (LP) turbine 118, and a jet exhaust nozzle section 120. The compressor section, the combustion section 114, and the turbine section together define at least in part a core air flowpath 121 extending from the inlet 108 to the jet exhaust nozzle section 120. The turbofan engine further includes one or more drive shafts. More specifically, the turbofan engine includes a high-pressure (HP) shaft or spool 122 drivingly connecting the HP turbine 116 to the HP compressor 112, and a low-pressure (LP) shaft or spool 124 drivingly connecting the LP turbine 118 to the LP compressor 110.

The fan section 102 shown in FIG. 2 includes a fan 126 having a plurality of fan blades 128 coupled to a disk 130. The plurality of fan blades 128 and the disk 130 are rotatable, together, about the longitudinal centerline (axis) 101 by the LP shaft 124. The LP compressor 110 may also be directly driven by the LP shaft 124, as depicted in FIG. 2. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially spaced outlet guide vanes 136. A downstream section 138 of the nacelle 134 extends over an outer portion of the turbomachine 104 so as to define a bypass airflow passage 140 therebetween.

The turbofan engine 100 is operable with the fuel system 150 and receives a flow of fuel from the fuel system 150. The fuel system 150 includes a fuel delivery assembly 153 providing the fuel flow from the fuel tank 151 to the turbofan engine 100, and, more specifically, to a plurality of fuel injectors 200 that inject fuel into a combustion chamber 302 of a combustor 300 (see FIG. 3, discussed further below) of the combustion section 114. The components of the fuel system 150, and, more specifically, the fuel tank 151, is an example a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within a combustion chamber 302 of the combustor 300.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 302 and combusted. Adjusting the fuel metering unit 157 changes the volume of fuel provided to the combustion chamber 302 and, thus, changes the amount of propulsive thrust produced by the engine 100 to propel the aircraft 10.

The turbofan engine 100 also includes various accessory systems to aid in the operation of the turbofan engine 100 and/or an aircraft, including the turbofan engine 100. For example, the turbofan engine 100 may include a main lubrication system 162, a compressor cooling air (CCA) system 164, an active thermal clearance control (ATCC) system 166, and a generator lubrication system 168, each of which is depicted schematically in FIG. 2. The main lubrication system 162 is configured to provide a lubricant to, for example, various bearings and gear meshes in the compressor section, the turbine section, the HP spool 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/ heat removal for the electronic generator. The electronic generator may provide electrical power to, for example, a startup electrical motor for the turbofan engine 100 and/or various other electronic components of the turbofan engine 100 and/or an aircraft including the turbofan engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

It will be appreciated, however, that the turbofan engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, it will further be appreciated that, in other embodiments, the gas turbine engine may have other suitable configurations, such as other suitable numbers or arrangements of shafts, compressors, turbines, fans, etc. Further, although the turbofan engine 100 is shown as a direct drive, fixed-pitch turbofan engine 100, in other embodiments, a gas turbine engine may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, still, in alternative embodiments, aspects of the present disclosure may be incorporated into, or otherwise utilized with any other type of engine, such as reciprocating engines. Additionally, in still other exemplary embodiments, the exemplary turbofan engine 100 may include or be operably connected to any other suitable accessory systems. Additionally, or alternatively, the exemplary turbofan engine 100 may not include or be operably connected to one or more of the accessory systems 162, 164, 166, 168, discussed above.

FIG. 3 shows a combustor 300 of the combustion section 114 according to an embodiment of the present disclosure. FIG. 3 is a detail view showing detail 3 in FIG. 2. The combustor 300 is an annular combustor that includes a combustion chamber 302 defined between an inner liner 304 and an outer liner 306. Each of the inner liner 304 and outer liner 306 is annular about the longitudinal centerline 101 of the engine 100 (FIG. 2). The combustor 300 also includes a combustor case 308 that is also annular about the longitudinal centerline 101 of the engine 100. The combustor case 308 extends circumferentially around the inner liner 304 and the outer liner 306, and the inner liner 304 and outer liner 306 are located radially inward of the combustor case 308. The combustor 300 also includes a dome 310 mounted to a forward end of each of the inner liner 304 and the outer liner 306. The dome 310 defines an upstream (or forward end) of the combustion chamber 302.

A plurality of mixer assemblies 210 (only one is illustrated in FIG. 3) are spaced around the dome 310. The plurality of mixer assemblies 210 are circumferentially spaced about the longitudinal centerline 101 of the engine 100. In the embodiment shown in FIG. 3, each mixer assembly 210 is a twin annular premixing swirler (TAPS) that includes a main mixer 212 and a pilot mixer 214. The pilot mixer 214 is supplied with fuel from the fuel injector 200 during the entire engine operating cycle, and the main mixer 212 is supplied with fuel from the fuel injector 200 only during increased power conditions of the engine operating cycle, such as take-off and climb, for example. The TAPS mixer assembly 210 is provided by way of example and the catalytic metal layer discussed herein may be applied to other mixer assembly designs and other combustor designs.

As noted above, the compressor section, including the HP compressor 112 (FIG. 2), pressurizes air, and the combustor 300 receives an annular stream of this pressurized air from a discharge outlet (compressor discharge outlet 216) of the HP compressor 112. This air may be referred to as compressor discharge pressure air. A portion of the compressor discharge air flows into the mixer assembly 210. Fuel is injected into the air in the mixer assembly 210 to mix with the air and to form a fuel-air mixture. The fuel-air mixture is provided to the combustion chamber 302 from the mixer assembly 210 for combustion. Ignition of the fuel-air mixture is accomplished by a suitable igniter 312, and the resulting combustion gases flow in an axial direction toward and into an annular, first stage turbine nozzle 314. The first stage turbine nozzle 314 is defined by an annular flow channel that includes a plurality of radially extending, circularly-spaced nozzle vanes 316 that turn the gases so that they flow angularly and impinge upon the first stage turbine blades (not shown) of a first turbine (not shown) of the HP turbine 116 (FIG. 2).

The fuel injector 200 is fixed to the combustor case 308 by a nozzle mount. In this embodiment, the nozzle mount is a flange 202 that is integrally formed with a stem 204 of the fuel injector 200. The flange 202 is fixed to the combustor case 308 and sealed to the combustor case 308. The stem 204 includes a flow passage through which the hydrocarbon fuel flows, and the stem 204 extends radially inward from the flange 202. The fuel injector 200 also includes a fuel nozzle tip 220 through which fuel is injected into the combustion chamber 302 as part of the mixer assembly 210.

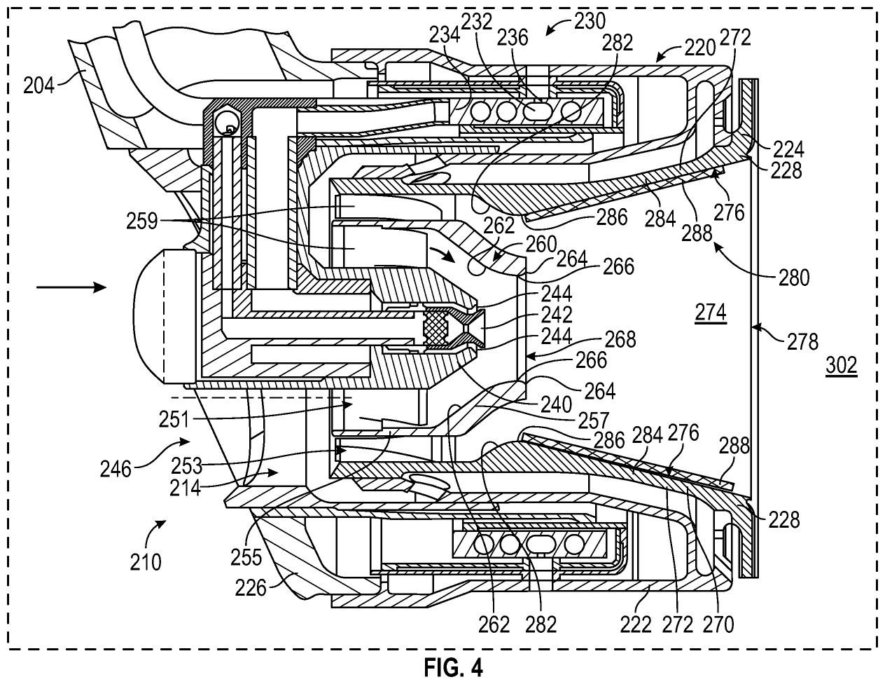

FIG. 4 shows the mixer assembly 210 of the combustor 300 shown in FIG. 3. FIG. 4 is a detail view showing detail 4 in FIG. 3, and, as FIG. 3 is a cross-sectional view, FIG. 4 is also a cross-sectional view of the mixer assembly 210. The fuel nozzle tip 220 includes a fuel nozzle body 222 and an aft heat shield 224 attached to the fuel nozzle body 222. The fuel nozzle body 222 is mounted to an inlet fairing 226. The inlet fairing 226 is connected to or integral with the stem 204. The fuel nozzle body 222 includes a main fuel nozzle 230 and a dual orifice pilot fuel injector tip 240 having a primary pilot fuel orifice 242 and a secondary pilot fuel orifice 244. The primary pilot fuel orifice 242 and the secondary pilot fuel orifice 244 may be substantially concentric with each other and substantially centered in an annular pilot inlet 246. The main fuel nozzle 230 surrounds the pilot inlet 246, and the pilot inlet 246 is located between the main fuel nozzle 230 and the dual orifice pilot fuel injector tip 240. In this embodiment, the fuel nozzle tip 220 is circular about an axis extending through the center of the primary pilot fuel orifice 242. In the discussion below, various features of the fuel nozzle tip 220 may be discussed relative to this axis.

Fuel is provided through the stem 204 to the main fuel nozzle 230. The main fuel nozzle 230 includes an annular main fuel passage 232 disposed in an annular main fuel ring 234. The main fuel nozzle 230 includes a circular array of main fuel injection orifices 236 or an annular array of main fuel injection orifices 236 extending radially outward from the annular main fuel passage 232 and through the wall of the annular main fuel ring 234. The main fuel nozzle 230 and the annular main fuel ring 234 are spaced radially outward of the primary pilot fuel orifice 242 and the secondary pilot fuel orifice 244. The main fuel nozzle 230 injects fuel in a radially outward direction through the circular array of main fuel injection orifices 236.

Fuel is also provided through the stem 204 to the primary pilot fuel orifice 242 and the secondary pilot fuel orifice 244. The secondary pilot fuel orifice 244 is radially located directly adjacent to the primary pilot fuel orifice 242 and surrounds the primary pilot fuel orifice 242. The pilot mixer 214 includes an inner pilot swirler 251, an outer pilot swirler 253, and a swirler splitter 255 positioned between the inner pilot swirler 251 and the outer pilot swirler 253. The inner pilot swirler 251 is located radially outward of the dual orifice pilot fuel injector tip 240 and adjacent to the dual orifice pilot fuel injector tip 240. The outer pilot swirler 253 is located radially outward of the inner pilot swirler 251. The swirler splitter 255 extends downstream of the dual orifice pilot fuel injector tip 240 and a first venturi 260 is formed in a downstream portion 257 of the swirler splitter 255. The first venturi 260 includes a converging section 262, a diverging section 264, and a throat 266 between the converging section 262 and the diverging section 264. The throat 266 is located downstream of the primary pilot fuel orifice 242 and the secondary pilot fuel orifice 244. The swirler splitter 255 and, more specifically, the downstream portion 257 of the swirler splitter 255 forms a housing for the first venturi 260. The inner pilot swirler 251 and the outer pilot swirler 253 are generally oriented parallel to a centerline of the dual orifice pilot fuel injector tip 240. The inner pilot swirler 251 and the outer pilot swirler 253 include a plurality of swirling vanes 259 for causing air traveling therethrough to swirl.

A portion of the compressor discharge air flows into the mixer assembly pilot inlet 246 and, then, into the inner pilot swirler 251 and the outer pilot swirler 253. As noted above, fuel and air are provided to the pilot mixer 214 at all times during the engine operating cycle so that a primary combustion zone is produced within a central portion of the combustion chamber 302. The primary pilot fuel orifice 242 is circular, and the secondary pilot fuel orifice 244 is annular. Each of the primary pilot fuel orifice 242 and the secondary pilot fuel orifice 244 injects fuel in a generally downstream direction and into the compressed air flowing through the inner pilot swirler 251. The primary pilot fuel orifice 242 and the secondary pilot fuel orifice 244 are examples of a fuel injection port that is fluidly connected to a fuel source and configured to inject a hydrocarbon fuel into the mixer assembly. This fuel and air mixture flows through the first venturi 260 and exits through a circular outlet 268. The outlet 268 is downstream of the diverging section 264.

The pilot mixer 214 is supported by an annular pilot housing 270. The pilot housing 270 includes a conical wall section 272 circumscribing a conical pilot mixing chamber 274 that is in flow communication with, and downstream from, the pilot mixer 214, and more specifically, the outlet 268. The pilot mixing chamber 274 is also fluidly connected to the primary pilot fuel orifice 242 and the secondary pilot fuel orifice and downstream of the primary pilot fuel orifice 242 and the secondary pilot fuel orifice 244. The pilot mixing chamber 274 is a passage of the fuel injector 200 and, more specifically, the fuel nozzle tip 220. As the fuel nozzle tip 220 is also a portion of the mixer assembly 210, the pilot mixing chamber 274 also is a passage of the mixer assembly 210. The conical wall section 272 of the pilot housing 270 is thus a passage wall that includes a passage wall surface 276 facing the pilot mixing chamber 274 (passage). In this embodiment, the conical wall section 272 is part of a second venturi 280 formed by the pilot housing 270. The second venturi 280 includes a converging section 282, a diverging section 284, and a throat 286 between the converging section 282 and the diverging section 284. The diverging section 284 is provided by the conical wall section 272, which extends downstream from the throat 286 and continues with diverging surfaces 228 of the aft heat shield 224. The diverging surfaces 228 of this embodiment form a conical wall section of the aft heat shield 224 that is coplanar with the wall surface 276 of the conical wall section 272. Diverging section 284 has an upstream end, which, in this embodiment, is the throat 286 and a downstream end, which, in this embodiment, is an outlet 278 of the pilot mixing chamber 274. As can be seen in FIG. 4, the cross-sectional area of the second venturi 280 at the outlet 278 (the downstream end) is greater than the cross-sectional area of the second venturi 280 at the throat 286 (the upstream end).

Air flows through the outer pilot swirler 253 through the converging section 282 toward the throat 286. This air is mixed with the fuel-air mixture from the outlet 268 and through the throat 286 to the diverging section 284 and the aft heat shield 224. The pilot mixing chamber 274 and, more specifically, the wall surface 276 of the conical wall section 272 are exposed to hydrocarbon fuel as the fuel-air mixture flows through the pilot mixing chamber 274, through the outlet 278 of the pilot mixing chamber 274, and into the combustion chamber 302. Being adjacent to the combustion chamber 302 and adjacent to the primary combustion zone, the fuel, the conical wall section 272, and aft heat shield 224 are exposed to high temperatures. For example, the conical wall section 272 and the aft heat shield 224 may be at temperatures from six hundred degrees Fahrenheit to one thousand one hundred degrees Fahrenheit. The pilot housing 270 and the aft heat shield 224 are made from materials suitable for use in these high temperature environments including, for example, stainless steel, corrosion-resistant alloys of nickel and chromium, and high-strength nickel-base alloys. The pilot housing 270 and aft heat shield 224 may thus be formed from a metal alloy chosen from the group consisting of iron-based alloys, nickel-based alloys, and chromium-based alloys. Exposed surfaces of these materials at these temperatures, and, more particularly, the wall surface 276 may thus be susceptible to a significant build-up of coke and/or partially burned fuel deposits. The coke forming on such materials may be strongly bound to these metallic components of the fuel nozzle tip 220 leading to the formation of a thick layer of coke with large particles. As noted above, coke can build up in considerable thickness on these surfaces and large pieces of coke can shed off, becoming internal domestic objects that can cause significant damage to components downstream of the fuel nozzle (hot gas path components).

To prevent the build-up of coke and the issues discussed above, at least a portion of the surfaces of the second venturi 280, including, for example, the wall surface 276 and the aft heat shield 224 may be coated with a layer of a catalytic metal (referred to herein as a catalytic metal layer 288) to inhibit coke deposition and build-up. As noted above, the pilot mixing chamber 274 is passage, and, in embodiments discussed herein, a portion of the passage wall is a coated passage wall that is coated with a layer of a catalytic metal (the catalytic metal layer 288). coated passage wall is located downstream of the fuel injection port (the primary pilot fuel orifice 242 and the secondary pilot fuel orifice 244, in this embodiment). As noted above, air flows through the pilot mixing chamber 274 (passage) and is introduced by an air inlet. In these embodiments, the air inlet is upstream of the coated passage wall. More specifically, air is introduced into the pilot mixing chamber 274 (passage) by the pilot inlet 246, through the inner pilot swirler 251 and the outer pilot swirler 253. The air flowing through the inner pilot swirler 251 is also introduced to the pilot mixing chamber 274 via outlet 268.

Suitable catalytic metals include the platinum group metals, and the catalytic metal may be a metal selected from the group consisting of ruthenium, rhodium, palladium, osmium, iridium, and platinum. Of this group, palladium and platinum may be preferred catalytic metals. Gold may also be a suitable metal, and, in some embodiments, the catalytic metal may be one of palladium, platinum, or gold. Without intending to be bound to any theory, these catalytic metals promote the formation of fine scale (less than one hundred microns in size) filaments of coke, rather than large grains of coke (greater than two hundred microns in size). These filaments of coke are lightly bound (do not from a strong bond) to the catalytic metal layer 288 and the filamentary coke can be easily removed by normal operation of the fuel nozzle without damage to downstream components.

Exposed surfaces of the underlying (base) material of the pilot housing 270, and, more specifically, the conical wall section 272 or the aft heat shield 224, promote the formation of thick, large grains of coke, and the catalytic metal layer 288 of this embodiment is applied as a continuous layer on the wall surface 276 to avoid discontinuities that would expose the base material. Only a thin layer of the catalytic metal is needed to promote the filamentary coke formation. As these catalytic metals may be expensive, the thickness of the catalytic metal layer 288 is preferably minimized. The catalytic metal layer 288 may have a thickness of, preferably, less than fifty microns, and, more preferably, less than twenty-five microns. In some embodiments, the thickness of the catalytic metal layer 288 may be from five microns to ten microns.

For aerodynamic purposes related to the flow of the fuel-air mixture through the pilot mixing chamber 274, the catalytic metal layer 288 preferably has a very smooth surface finish. A smooth surface finish also helps to prevent coke from sticking to the second venturi 280. In some embodiments, the catalytic metal layer 288 may have a surface finish (a surface roughness, Ra) from twenty microinches to one hundred fifty microinches and, in other embodiments, from eighty microinches to one hundred fifty microinches.

The catalytic metal layer 288 may be applied using any suitable method that produces a continuous metal layer with the thicknesses and surface finishes discussed above. The components discussed herein, such as the diverging section 284 of the second venturi 280 and the diverging surfaces 228 of the aft heat shield 224, can be preferably coated using a line-of-sight process, such as electroplating, for example, as opposed to other processes, such as chemical vapor deposition. When electroplating is used, the electroplating process may be carried out using the equipment, capabilities, and experience found at a commercial plating shop within the aerospace industry. The electroplating may be performed using the following conditions for the bath. The catalytic metal layer 288 can be plated from an electrolytic plating bath containing the catalytic metal salts in either the (II) or (IV) oxidation state. The temperature of the bath during coating may be from seventy-five to eighty-five degrees Celsius. The current density may be from six to ten amperes per square foot (Amp/ft² or asf). The pH of the bath, measured at room temperature, may be from eleven to thirteen. The conductivity of the solution, measured at room temperature, may be from eight and a half milli Siemens per centimeter (mS/cm) to twelve milliSiemens per centimeter (mS/cm). The solution may be stirred at a stir rate of sixty to three hundred revolutions per minute (rpm). Depending upon the desired thickness, electroplating may be performed for one to three hours.

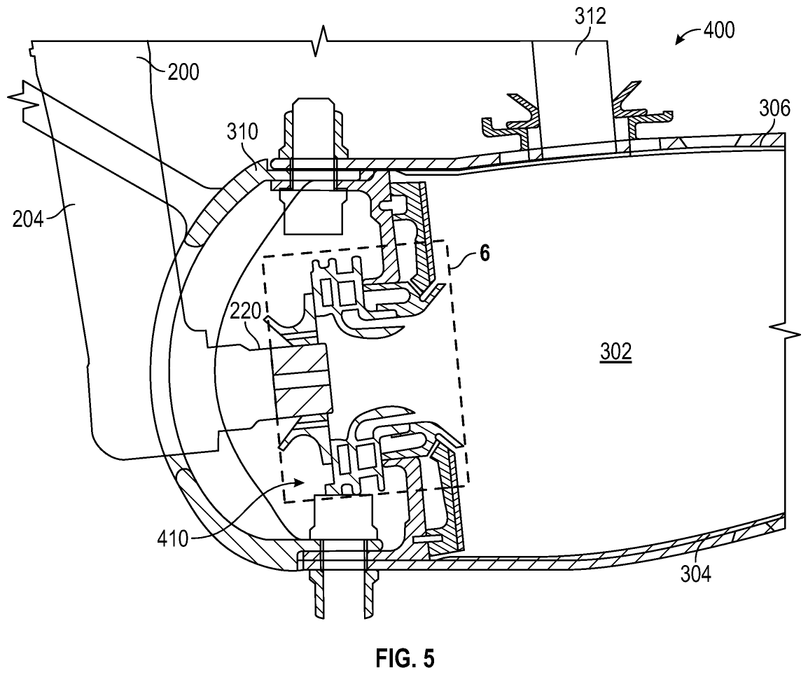

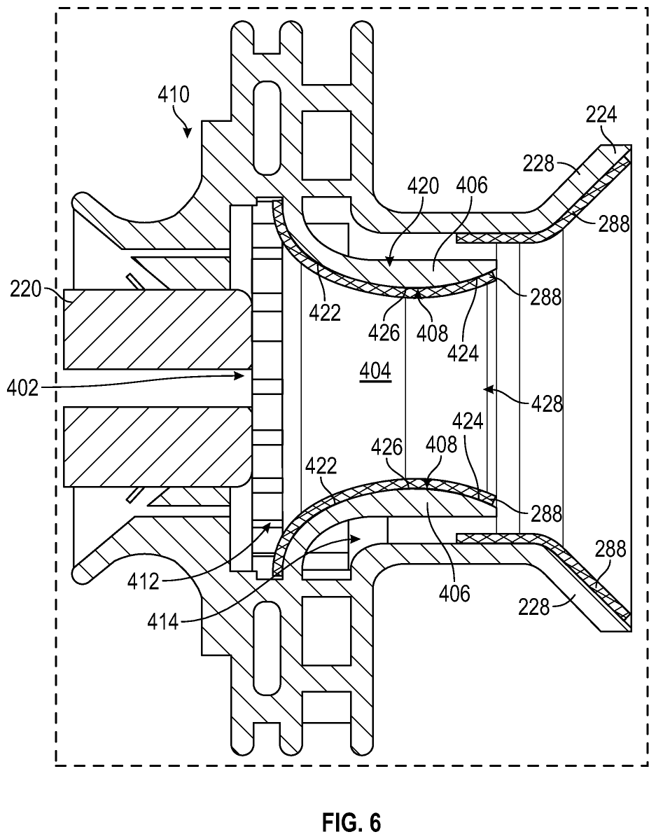

In the preceding discussion, the combustor 300 and the mixer assembly 210 were configured to use a twin annular premixing swirler (TAPS), but the catalytic metal layer 288 discussed herein may be applied to other mixer assembly designs and other combustor designs. Another example of a combustor 400 is shown in FIG. 5. FIG. 5 is a detail view showing detail 3 in FIG. 2 for a rich burn combustor design, and, as FIG. 2 is a cross-sectional view, FIG. 5 is also a cross-sectional view of the combustor 400. FIG. 6 shows a mixer assembly 410 of the combustor 400 shown in FIG. 5. FIG. 6 is a detail view showing detail 6 in FIG. 5, and, as FIG. 5 is a cross-sectional view, FIG. 6 is also a cross-sectional view of the mixer assembly 410. The combustor 400 and the mixer assembly 410 of this embodiment include the same or similar components as the combustor 300 and the mixer assembly 210 discussed above. Components in this embodiment that are the same or similar to those discussed above are identified with the same reference numeral and a detailed description of these components is omitted.

The combustor 400 of this embodiment shows a rich burn combustor. A plurality of mixer assemblies 410 (only one is illustrated) are spaced around the dome 310. As shown in FIG. 6, the mixer assembly 410 of this embodiment includes an inner swirler 412 and an outer swirler 414 through which compressed air flows. Fuel is injected into the mixer assembly 410 by a fuel injection port 402. The fuel injection port 402 injects fuel in a generally downstream direction and into the compressed air flowing through the inner swirler 412. The fuel is injected into a mixing chamber 404 that mixes the fuel with the compressed air to form a fuel-air mixture. As with the pilot mixing chamber 274 discussed above, the mixing chamber 404 of this embodiment is a passage of the fuel injector 200 with a wall section 406 that includes a passage wall surface 408 facing the mixing chamber 404 (passage). In this embodiment, wall section 406 is part of a venturi 420 that includes a converging section 422, a diverging section 424, and a throat 426 between the converging section 422 and the diverging section 424. In this embodiment, the catalytic metal layer 288 is formed on the surfaces of the venturi 420. The fuel-air mixture exits through an outlet 428 of the mixing chamber 404 and is combined with air flowing through the outer swirler 414 at a position upstream of the diverging surfaces 228 of the aft heat shield 224. In this embodiment, catalytic metal layer 288 is also formed on the diverging surfaces 228 of the aft heat shield 224.

Our testing confirmed the effectiveness of applying the catalytic metal to exposed surfaces of the fuel nozzle tip 220 in the manner discussed in the embodiments above. One such test was an engine-simulative combustion test. In this test, we applied a layer of platinum as the catalytic metal layer 288 to the diverging section 284 of the second venturi 280 in a twin annular premixing swirler (TAPS) to form a coated venturi (See FIG. 4). We applied the platinum to the diverging section 284 using electroplating under conditions discussed above. We compared the coated venturi to a fuel nozzle tip 220, operated under similar conditions, without the coated venturi (non-coated venturi). We ran the engine-simulative combustion test for a duration of about two hours with a controlled ramp up after ignition, a hold at condition for about forty-five minutes, a controlled cool down, and flameout. We measured the starting temperature at the inlet at four hundred degrees Fahrenheit, increasing to about one thousand degrees in the space of fifty minutes. We held the temperature constant at about one thousand degrees for forty-five minutes, and then began the cool down and flameout, allowing the temperature to decrease to two hundred degrees two hours after the initial measurement. During the test, we maintained a relatively constant fuel flow rate of about two hundred pounds mass per hour. During cool down and flameout, we first increased the fuel flow rate to about two hundred thirty pounds mass per hour for a half hour, before flaming out by cutting fuel flow to the fuel nozzle. The inlet pressure was measured at about ninety pounds per square inch absolute at the start of the cycle and was gradually increased to one hundred eighty pounds per square inch absolute for the forty-five-minute hold. During cool down, about an hour into the test, the inlet pressure linearly decreased to about one hundred sixty pounds per square inch absolute at the end when the fuel flow was stopped.

Each of the coated venturi and the non-coated venturi showed coke deposition. We performed an adhesion test by applying a piece of transparent office tape, such as Scotch® Magic™ Tape, with the adhesive side on the coke of each venturi. We then peeled off the tape and observed the coke adhered to the tape. More coke was removed from the platinum coated venturi than the non-coated venturi, and the morphology of the coke was different between the two. The coke from the platinum coated venturi displayed a filamentary morphology and was of a finer scale than the coke from the non-coated venturi. As demonstrated by this test, catalytic metal coating, such as the platinum catalytic coating, on the venturi can effectively reduce coke buildup during engine operation.

Further aspects of the present disclosure are provided by the subject matter of the following clauses.

A mixer assembly for a gas turbine engine includes a housing and a fuel injection port. The housing includes a passage formed therein and a passage wall facing the passage. The fuel injection port is fluidly connected to a fuel source and configured to inject a hydrocarbon fuel into the passage. At least a portion of the passage wall is a coated passage wall. The coated passage wall is (i) coated with a layer of a catalytic metal and (ii) located downstream of the fuel injection port.

The mixer assembly of the preceding clause, wherein the layer of the catalytic metal of the coated passage wall has a surface roughness. The surface roughness is from twenty microinches to one hundred fifty microinches.

The mixer assembly of any of the preceding clauses, wherein the catalytic metal is a metal selected from the group consisting of ruthenium, rhodium, palladium, osmium, iridium, and platinum.

The mixer assembly of any of the preceding clauses, wherein the catalytic metal is one of palladium, platinum, or gold.

The mixer assembly of any of the preceding clauses, wherein the layer of the catalytic metal has a thickness that is less than twenty-five microns.

The mixer assembly of any of the preceding clauses, wherein the layer of the catalytic metal has a thickness that is from five microns to ten microns.

The mixer assembly of any of the preceding clauses, wherein the layer of the catalytic metal is an electroplated layer.

The mixer assembly of any of the preceding clauses, wherein the passage wall is formed from a metal alloy chosen from the group consisting of iron-based alloys, nickel-based alloys, and chromium-based alloys.

The mixer assembly of any of the preceding clauses, wherein the passage includes a conical section. A passage wall of the conical section of the passage is the coated passage wall.

The mixer assembly of any of the preceding clauses, wherein the conical section has an upstream end and a downstream end. The passage has a cross-sectional area at each of the upstream end and the downstream end. The cross-sectional area of the passage at the downstream end of the conical section is greater than the cross-sectional area of the passage at the upstream end of the conical section.

The mixer assembly of any of the preceding clauses, further comprising an air inlet configured to introduce air to flow through the air inlet into the passage. The air inlet is upstream of the coated passage wall.

The mixer assembly of any of the preceding clauses, wherein the passage is a venturi including a converging section, a diverging section, and a throat. The coated passage wall includes the passage wall of the diverging section.

The mixer assembly of any of the preceding clauses, wherein the coated passage wall includes the passage wall of the converging section.

The mixer assembly of any of the preceding clauses, further comprising a pilot fuel injector tip and a pilot swirler. The pilot fuel injector tip includes a least one pilot fuel orifice. The fuel injection port is the pilot fuel orifice. The pilot swirler is located radially outward of the pilot fuel injector tip and adjacent to the pilot fuel injector tip. Air is configured to flow through the pilot swirler and to mix with fuel from the pilot fuel orifice as a fuel-air mixture. The pilot swirler has an outlet configured to discharge the fuel-air mixture into the passage.

The mixer assembly of any of the preceding clauses, further comprising an array of main fuel injection orifices configured to inject fuel in a radially outward direction. The main fuel injection orifices are located radially outward from the passage.

The mixer assembly of any of the preceding clauses, wherein the passage is a venturi including a converging section, a diverging section, and a throat. The coated passage wall includes a passage wall of the diverging section, and the outlet of the pilot swirler is located upstream of the diverging section.

The mixer assembly of any of the preceding clauses, wherein the pilot swirler is formed by a housing. The housing is shaped as a venturi.

A gas turbine engine includes a combustor including a combustion chamber, and the mixer assembly of any of the preceding clauses. The mixer assembly is configured to inject a mixture of air and hydrocarbon fuel into the combustion chamber.

The gas turbine engine of the preceding clause, wherein the combustor is configured to combust the mixture of air and the hydrocarbon fuel to generate combustion products, and wherein the gas turbine engine further comprises at least one component coated with a thermal barrier coating downstream of the combustor and configured to receive the combustion products.

The gas turbine engine of any of the preceding clauses, wherein the mixer assembly includes a heat shield adjacent to the combustion chamber. At least a portion of the heat shield is coated with a layer of the catalytic metal.

Although the foregoing description is directed to the preferred embodiments, other variations and modifications will be apparent to those skilled in the art and may be made without departing from the spirit or scope of the disclosure. Moreover, features described in connection with one embodiment may be used in conjunction with other embodiments, even if not explicitly stated above.

1. A mixer assembly for a gas turbine engine, the mixer assembly comprising:
a housing including a passage formed therein and a passage wall facing the passage; and
a fuel injection port fluidly connected to a fuel source and configured to inject a hydrocarbon fuel into the passage,
wherein at least a portion of the passage wall is a coated passage wall, the coated passage wall being (i) coated with a layer of a catalytic metal and (ii) located downstream of the fuel injection port.

2. The mixer assembly of claim 1, wherein the layer of the catalytic metal of the coated passage wall has a surface roughness, the surface roughness being from twenty microinches to one hundred fifty microinches.

3. The mixer assembly of claim 1, wherein the catalytic metal is a metal selected from the group consisting of ruthenium, rhodium, palladium, osmium, iridium, and platinum.

4. The mixer assembly of claim 1, wherein the catalytic metal is one of palladium, platinum, or gold.

5. The mixer assembly of claim 1, wherein the layer of the catalytic metal has a thickness that is less than twenty-five microns.

6. The mixer assembly of claim 1, wherein the layer of the catalytic metal has a thickness that is from five microns to ten microns.

7. The mixer assembly of claim 1, wherein the layer of the catalytic metal is an electroplated layer.

8. The mixer assembly of claim 1, wherein the passage wall is formed from a metal alloy chosen from the group consisting of iron-based alloys, nickel-based alloys, and chromium-based alloys.

9. The mixer assembly of claim 1, wherein the passage includes a conical section, a passage wall of the conical section of the passage being the coated passage wall.

10. The mixer assembly of claim 9, wherein the conical section has an upstream end and a downstream end, the passage having a cross-sectional area at each of the upstream end and the downstream end, the cross-sectional area of the passage at the downstream end of the conical section being greater than the cross-sectional area of the passage at the upstream end of the conical section.

11. The mixer assembly of claim 1, further comprising an air inlet configured to introduce air to flow through the air inlet into the passage, the air inlet being upstream of the coated passage wall.

12. The mixer assembly of claim 11, wherein the passage is a venturi including a converging section, a diverging section, and a throat, the coated passage wall including the passage wall of the diverging section.

13. The mixer assembly of claim 12, wherein the coated passage wall further includes the passage wall of the converging section.

14. The mixer assembly of claim 1, further comprising:
a pilot fuel injector tip including a least one pilot fuel orifice, the fuel injection port being the pilot fuel orifice; and
a pilot swirler is located radially outward of the pilot fuel injector tip and adjacent to the pilot fuel injector tip, air being configured to flow through the pilot swirler and to mix with fuel from the pilot fuel orifice as a fuel-air mixture, the pilot swirler having an outlet configured to discharge the fuel-air mixture into the passage.

15. The mixer assembly of claim 14, further comprising an array of main fuel injection orifices configured to inject fuel in a radially outward direction, the main fuel injection orifices being located radially outward from the passage.

16. The mixer assembly of claim 14, wherein the passage is a venturi including a converging section, a diverging section, and a throat, the coated passage wall including a passage wall of the diverging section, and the outlet of the pilot swirler being located upstream of the diverging section.

17. The mixer assembly of claim 16, wherein the pilot swirler is formed by a housing, the housing being shaped as a venturi.

18. A gas turbine engine comprising:
a combustor including a combustion chamber; and
the mixer assembly of claim 1 configured to inject a mixture of air and hydrocarbon fuel into the combustion chamber.

19. The gas turbine engine of claim 18, wherein the combustor is configured to combust the mixture of air and the hydrocarbon fuel to generate combustion products, and
wherein the gas turbine engine further comprises at least one component coated with a thermal barrier coating downstream of the combustor and configured to receive the combustion products.

20. The gas turbine engine of claim 18, wherein the mixer assembly includes a heat shield adjacent to the combustion chamber, at least a portion of the heat shield being coated with a layer of the catalytic metal.
